(19) United States
(12) Patent Application Publication
(10) Pub. No.: US 2018/0300289 A1
(43) Pub. Date: Oct. 18, 2018

(54) Information Determining Method and Apparatus

(71) Applicant: Huawei Technologies Co., Ltd., Shenzhen (CN)

(72) Inventors: Nan Hu, Shenzhen (CN); Lifeng Xu, Shenzhen (CN); Guanlv Zhang, Shenzhen (CN); Yong Zhong, Shenzhen (CN)

(21) Appl. No.: 16/013,433

(22) Filed: Jun. 20, 2018

Related U.S. Application Data
(63) Continuation of application No. PCT/CN2016/097816, filed on Sep. 1, 2016.

(30) Foreign Application Priority Data
Dec. 21, 2015 (CN) 201510959360.9

(51) Int. Cl. G06F 17/18; G06F 17/16; G06F 17/17; G06F 17/30

(52) U.S. Cl. CPC G06F 17/18; G06F 17/16; G06F 17/30318; G06F 17/30592; G06F 17/30687; G06F 17/175

(57) ABSTRACT

An information determining method and apparatus are provided. The method includes: estimating an association relationship between a feature vector and to-be-predicted attribute information of a unlabeled sample; decomposing the association relationship into N sub-association relationships in a one-to-one correspondence to N fields, and a feature vector of each sample into feature subvectors in a one-to-one correspondence to the N fields; obtaining a first value obtained by substituting a feature subvector of each labeled sample into a corresponding sub-association relationship; calculating, based on public attribute information, a sum of first values obtained in the N fields for a same user to obtain estimated attribute information; determining the association relationship based on estimated attribute information of all labeled samples and known attribute information corresponding to the estimated attribute information; and determining the to-be-predicted attribute information based on the determined association relationship and the feature vector of the to-be-labeled sample.

### CROSS-REFERENCE TO RELATED APPLICATIONS

This application is a continuation of International Application No. PCT/CN2016/097816, filed on Sep. 1, 2016, which claims priority to Chinese Patent Application No. 201510959360.9, filed on Dec. 21, 2015. The disclosures of the aforementioned applications are hereby incorporated by reference in their entireties.

### TECHNICAL FIELD

Embodiments of the present application relate to big data analytics technologies, and in particular, to an information determining method and apparatus.

### BACKGROUND

Big data analytics typically refers to analysis of massive data. Big data may be summarized as four Vs: a large data volume, a high velocity, a great variety, and veracity. Compared with analysis of a small volume of data, the big data analytics may provide a more accurate data analysis result. Application of the big data analytics may bring tremendous changes and value to the society, economy, and production.

The data convergence technology refers to a technology of information processing performed to automatically analyze and combine, according to a rule and using a computer, several pieces of observation information obtained in a time sequence, to complete required decision-making and assessment tasks. Therefore, cross-field data convergence enables the big data analytics to bring greater value into play. Data convergence for two fields generates an effect of 1+1>2.

It is assumed that instance data of a same user in different fields needs to be analyzed to estimate to-be-predicted attribute information of the user. The instance data herein may include a plurality of pieces of attribute information. For example, attribute information included in instance data of a user A in a mobile operator may include a name, a mobile number, consumption information, and the like, while attribute information included in instance data of the user A in a bank may include the name, the mobile number, a service type, an amount related to the service type, and the like. To-be-predicted attribute information, such as the gender or the age, of the user A may be estimated using the known attribute information. A current method for processing big data analytics may comprise: data convergence for the two fields may first be implemented according to an identifier of the user A in the mobile operator and an identifier of the user A in the bank, where the identifiers herein may be public attribute information, such as the name, of the user A in the mobile operator and the bank, and to implement the data convergence may only require to perform data connection or combination in a plaintext manner. The converged data may be analyzed to estimate the to-be-predicted attribute information of the user.

The foregoing data analytics process based on the data convergence may be referred to as an information determining process. In the information determining process in the current method, to implement the data convergence may only require to perform data connection or combination in a plaintext manner. Consequently, confidentiality between data in different fields may not be ensured.

### SUMMARY

Embodiments of the present application provide an information determining method and apparatus, to more accurately determine to-be-predicted information by converging data in a plurality of fields while ensuring confidentiality between data in different fields.

According to a first aspect, an embodiment of the present application provides an information determining method. The method is based on N fields, N is an integer greater than or equal to 2, each of the fields includes instance data of a plurality of users, each piece of instance data includes a plurality of pieces of attribute information, at least one piece of public attribute information exists in instance data of a same user in the N fields, the instance data of the same user in the N fields constitutes one sample, a feature vector of the sample is generated based on some or all of known attribute information included in the sample, and a feature vector of each sample includes a same quantity of pieces of known attribute information. The method may include estimating an association relationship between a feature vector and to-be-predicted attribute information of a to-be-labeled sample, where the to-be-labeled sample may be a sample including at least one piece of to-be-predicted attribute information. The method may also include decomposing the association relationship into N sub-association relationships that are in a one-to-one correspondence to the N fields, and decomposing the feature vector of each sample into feature subvectors that are in a one-to-one correspondence to the N fields. The method may also include obtaining a first value obtained by substituting a feature subvector of each labeled sample in each field into a corresponding sub-association relationship. The method may further include: calculating, based on the public attribute information, a sum of first values obtained in the N fields for the same user to obtain estimated attribute information, where the estimated attribute information is attribute information that is in a labeled sample, that corresponds to the to-be-predicted attribute information, and that is estimated based on the association relationship and a feature vector of the labeled sample, and the labeled sample is a sample in which all attribute information included is known attribute information. The method may also include determining the association relationship based on estimated attribute information of all labeled samples and known attribute information corresponding to the estimated attribute information; and determining the to-be-predicted attribute information of the to-be-labeled sample based on the determined association relationship and the feature vector of the to-be-labeled sample.

In the method, the sum of the first values obtained in the N fields for the same user may be calculated based on the public attribute information to obtain estimated attribute information. That is, a calculation result may be obtained from each field without a need to know attribute information of each field. The calculation result of the same user is further calculated using the public attribute information, and finally the to-be-predicted attribute information is determined. In this way, confidentiality between data in the different fields is ensured.

Further, the calculating, based on the public attribute information, a sum of first values obtained in the N fields for the same user to obtain estimated attribute information includes: calculating, based on encrypted public attribute information, the sum of the first values obtained in the N fields for the same user to obtain the estimated attribute information, where the public attribute information is encrypted using a same encryption algorithm in the N fields.

All the fields may use the same encryption algorithm. Therefore, the encrypted public attribute information of each field may be the same. In the method, data in all of the N fields may not need to be converged, as long as matching of the data in the N fields may be implemented based on the encrypted public attribute information, so that the confidentiality between the data can be improved.

In an optional implementation, the determining the association relationship based on estimated attribute information of all labeled samples and known attribute information corresponding to the estimated attribute information may include: for each labeled sample, calculating a first difference between estimated attribute information and known attribute information corresponding to the estimated attribute information; and determining the association relationship by making a sum of the first differences corresponding to all the labeled samples minimum.

In another optional implementation, the method may further include: obtaining similarity weights between to-be-labeled samples in each field, where the similarity weight may be used for measuring a similarity between the instance data; obtaining a second value obtained by substituting a feature subvector of each to-be-labeled sample in each field into a corresponding sub-association relationship; and calculating second differences between the second values of the to-be-labeled samples in each field, calculating a sum of products of all second differences in each field and corresponding similarity weights. The method may also include: determining the association relationship may be based on estimated attribute information of all labeled samples and known attribute information corresponding to the estimated attribute information that may include: for each labeled sample, calculating a first difference between estimated attribute information and known attribute information corresponding to the estimated attribute information; and determining the association relationship based on a sum of the first differences corresponding to all the labeled samples and the sum of the products of all the second differences in each field and the corresponding similarity weights.

The association relationship between the feature vector and the to-be-predicted attribute information of the to-be-labeled sample may be relatively accurately determined using the foregoing two optional implementations.

Further, after the determining the association relationship based on estimated attribute information of all labeled samples and known attribute information corresponding to the estimated attribute information, the method may further included: correcting the association relationship, and using the corrected association relationship as an estimated new association relationship; and stopping when a quantity of corrections exceeds a preset value; or stopping when all association relationships converge. The correction process may be a learning process, and the association relationship may be made more accurate through constant learning.

According to a second aspect, an embodiment of this aspect provides an information determining method. The method may be based on N fields, wherein N is an integer greater than or equal to 2, each of the fields includes instance data of a plurality of users, each piece of instance data includes a plurality of pieces of attribute information, at least one piece of public attribute information exists in instance data of a same user in the N fields, the instance data of the same user in the N fields constitutes one sample, a feature vector of the sample is generated based on some or all of known attribute information included in the sample, a feature vector of each sample includes a same quantity of pieces of known attribute information. The method includes: estimating a probability distribution function of to-be-predicted attribute information according to a feature vector of a to-be-labeled sample, where the to-be-labeled sample is a sample including at least one piece of to-be-predicted attribute information. The method may also include decomposing the probability distribution function into N subfunctions that are in a one-to-one correspondence to the N fields, and decomposing the feature vector of each sample into feature subvectors that are in a one-to-one correspondence to the N fields. The method may also include obtaining a first value obtained by substituting a feature subvector of each labeled sample in each field into a corresponding subfunction. The method may further include: calculating, based on the public attribute information, a sum of first values obtained in the N fields for the same user to obtain a probability that attribute information that is in a labeled sample and that corresponds to the to-be-predicted attribute information is particular attribute information, where the labeled sample is a sample in which all attribute information included is known attribute information. The method may also include determining the probability distribution function according to the probability that the attribute information that is in the labeled sample and that corresponds to the to-be-predicted attribute information is the particular attribute information and whether the attribute information is actually the particular attribute information. The method may also include determining the to-be-predicted attribute information of the to-be-labeled sample based on the determined probability distribution function and the feature vector of the to-be-labeled sample.

In the process, the sum of the first values obtained in the N fields for the same user may be calculated based on the public attribute information to obtain the probability that the attribute information that is in the labeled sample and that corresponds to the to-be-predicted attribute information is the particular attribute information. That is, a calculation result may be obtained from each field without a need to know attribute information of each field. The calculation result of the same user may be further calculated using the public attribute information, and finally the to-be-predicted attribute information is determined. In this way, confidentiality between data in the different fields may be ensured.

Further, the calculating, based on the public attribute information, a sum of first values obtained in the N fields for the same user to obtain a probability that attribute information that is in a labeled sample and that corresponds to the to-be-predicted attribute information is particular attribute information may include: calculating, based on encrypted public attribute information, the sum of the first values obtained in the N fields for the same user to obtain the probability that the attribute information that is in the labeled sample and that corresponds to the to-be-predicted attribute information is the particular attribute information, where the public attribute information may be encrypted using a same encryption algorithm in the N fields.

All the fields may use the same encryption algorithm. Therefore, the encrypted public attribute information of each field may be the same. In the method, data in all of the N fields may not need to be converged, as long as matching of the data in the N fields is implemented based on the encrypted public attribute information, so that the confidentiality between the data can be improved.

In an optional implementation, the determining the probability distribution function according to the probability that the attribute information that is in the labeled sample and that corresponds to the to-be-predicted attribute information is the particular attribute information and whether the attribute information is actually the particular attribute information may include: when the attribute information that is in the labeled sample and that corresponds to the to-be-predicted attribute information corresponds to m pieces of particular attribute information, where m is a positive integer greater than or equal to 2, for each piece of the particular attribute information of each labeled sample, when the attribute information corresponding to the to-be-predicted attribute information is actually the particular attribute information, calculating a first difference between the probability and 1; otherwise, calculating a first difference between the probability and 0; and determining the probability distribution function by making a sum of all first differences minimum.

In another implementation, the method may further include: obtaining similarity weights between to-be-labeled samples in each field, where the similarity weight is used for measuring a similarity between the instance data; obtaining a second value obtained by substituting a feature subvector of each to-be-labeled sample in each field into a corresponding subfunction; and calculating second differences between the values of the to-be-labeled samples in each field, and calculating a sum of products of all second differences in each field and corresponding similarity weights; and the determining the probability distribution function according to the probability that the attribute information that is in the labeled sample and that corresponds to the to-be-predicted attribute information is the particular attribute information and whether the attribute information is actually the particular attribute information includes: for each piece of the particular attribute information of each labeled sample, when the attribute information corresponding to the to-be-predicted attribute information matches the particular attribute information, calculating a first difference between the probability and 1; otherwise, calculating a first difference between the probability and 0; and determining the probability distribution function based on a sum of the first differences corresponding to all the labeled samples and the sum of the products of all the second differences in each field and the corresponding similarity weights.

The probability distribution function of the to-be-predicted attribute information may be relatively accurately determined using the foregoing two optional implementations.

Further, after the determining the probability distribution function according to the probability that the attribute information that is in the labeled sample and that corresponds to the to-be-predicted attribute information is the particular attribute information and whether the attribute information is actually the particular attribute information, the method may further include: correcting the probability distribution function, and using the corrected probability distribution function as an estimated new probability distribution function; and stopping when a quantity of corrections exceeds a preset value; or stopping when all probability distribution functions converge. The correction process may be a learning process, and the probability distribution function may be made more accurate through constant learning.

The following describes an information determining apparatus according to an embodiment of the present application. The apparatus portion corresponds to the foregoing method, and technical effects of corresponding content are the same. Details are not described herein again.

According to a third aspect, an embodiment of the present application may provide an information determining apparatus. The apparatus may be based on N fields, wherein N is an integer greater than or equal to 2, each of the fields includes instance data of a plurality of users, each piece of instance data includes a plurality of pieces of attribute information, at least one piece of public attribute information exists in instance data of a same user in the N fields, the instance data of the same user in the N fields constitutes one sample, a feature vector of the sample is generated based on some or all of known attribute information included in the sample, a feature vector of each sample includes a same quantity of pieces of known attribute information. The apparatus may include: an estimation module, configured to estimate an association relationship between a feature vector and to-be-predicted attribute information of a to-be-labeled sample, where the to-be-labeled sample is a sample including at least one piece of to-be-predicted attribute information. The apparatus may also include a decomposition module, configured to: decompose the association relationship into N sub-association relationships that are in a one-to-one correspondence to the N fields, and decompose the feature vector of each sample into feature subvectors that are in a one-to-one correspondence to the N fields. The apparatus may also include an obtaining module, configured to obtain a first value obtained by substituting a feature subvector of each labeled sample in each field into a corresponding sub-association relationship. The apparatus may further include: a calculation module, configured to calculate, based on the public attribute information, a sum of first values obtained in the N fields for the same user to obtain estimated attribute information, where the estimated attribute information is attribute information that is in a labeled sample, that corresponds to the to-be-predicted attribute information, and that is estimated based on the association relationship and a feature vector of the labeled sample, and the labeled sample is a sample in which all attribute information included is known attribute information. The apparatus may also include a determining module, configured to determine the association relationship based on estimated attribute information of all labeled samples and known attribute information corresponding to the estimated attribute information. The determining module may be further configured to determine the to-be-predicted attribute information of the to-be-labeled sample based on the determined association relationship and the feature vector of the to-be-labeled sample.

Further, the calculation module is specifically configured to calculate, based on encrypted public attribute information, the sum of the first values obtained in the N fields for the same user to obtain the estimated attribute information, where the public attribute information may be encrypted using a same encryption algorithm in the N fields.

Optionally, the determining module may be configured to: for each labeled sample, calculate a first difference between estimated attribute information and known attribute information corresponding to the estimated attribute information, and determine the association relationship by making a sum of the first differences corresponding to all the labeled samples minimum.

Optionally, the obtaining module may be further configured to: obtain similarity weights between to-be-labeled samples in each field, where the similarity weight is used for measuring a similarity between the instance data, and obtain a second value obtained by substituting a feature subvector of each to-be-labeled sample in each field into a corresponding sub-association relationship. The calculation module is further configured to: calculate second differences between the second values of the to-be-labeled samples in each field, and calculate a sum of products of all second differences in each field and corresponding similarity weights. The determining module may be configured to: for each labeled sample, calculate a first difference between estimated attribute information and known attribute information corresponding to the estimated attribute information, and determine the association relationship based on a sum of the first differences corresponding to all the labeled samples and the sum of the products of all the second differences in each field and the corresponding similarity weights.

Still further, the apparatus may further include: a correction module, configured to: correct the association relationship, and use the corrected association relationship as an estimated new association relationship, and stop when a quantity of corrections exceeds a preset value, or stop when all association relationships converge.

According to a fourth aspect, an embodiment of the present application may provide an information determining apparatus. The apparatus may be based on N fields, N is an integer greater than or equal to 2, each of the fields includes instance data of a plurality of users, each piece of instance data includes a plurality of pieces of attribute information, at least one piece of public attribute information exists in instance data of a same user in the N fields, the instance data of the same user in the N fields constitutes one sample, a feature vector of the sample is generated based on some or all of known attribute information included in the sample, a feature vector of each sample includes a same quantity of pieces of known attribute information. The apparatus may include: an estimation module, configured to estimate a probability distribution function of to-be-predicted attribute information according to a feature vector of a to-be-labeled sample, where the to-be-labeled sample is a sample including at least one piece of to-be-predicted attribute information The apparatus may also include a decomposition module, configured to: decompose the probability distribution function into N subfunctions that are in a one-to-one correspondence to the N fields, and decompose the feature vector of each sample into feature subvectors that are in a one-to-one correspondence to the N fields. The apparatus may also include an obtaining module, configured to obtain a first value obtained by substituting a feature subvector of each labeled sample in each field into a corresponding subfunction. The apparatus may further include: a calculation module, configured to calculate, based on the public attribute information, a sum of first values obtained in the N fields for the same user to obtain a probability that attribute information that is in a labeled sample and that corresponds to the to-be-predicted attribute information is particular attribute information, where the labeled sample is a sample in which all attribute information included is known attribute information. The apparatus may also include a determining module, configured to determine the probability distribution function according to the probability that the attribute information that is in the labeled sample and that corresponds to the to-be-predicted attribute information is the particular attribute information and whether the attribute information is actually the particular attribute information. The determining module may be further configured to determine the to-be-predicted attribute information of the to-be-labeled sample based on the determined probability distribution function and the feature vector of the to-be-labeled sample.

Further, the calculation module may be configured to calculate, based on encrypted public attribute information, the sum of the first values obtained in the N fields for the same user to obtain the probability that the attribute information that is in the labeled sample and that corresponds to the to-be-predicted attribute information is the particular attribute information, where the public attribute information is encrypted using a same encryption algorithm in the N fields.

Optionally, the determining module may be configured to: when the attribute information that is in the labeled sample and that corresponds to the to-be-predicted attribute information corresponds to m pieces of particular attribute information, where m is a positive integer greater than or equal to 2, for each piece of the particular attribute information of each labeled sample, when the attribute information corresponding to the to-be-predicted attribute information is actually the particular attribute information, calculate a first difference between the probability and 1; otherwise, calculate a first difference between the probability and 0; and determine the probability distribution function by making a sum of all first differences minimum.

Optionally, the obtaining module may be further configured to: obtain similarity weights between to-be-labeled samples in each field, where the similarity weight is used for measuring a similarity between the instance data; and obtain a second value obtained by substituting a feature subvector of each to-be-labeled sample in each field into a corresponding subfunction; the calculation module may be further configured to: calculate second differences between the values of the to-be-labeled samples in each field, and calculate a sum of products of all second differences in each field and corresponding similarity weights; and the determining module may be configured to: for each piece of the particular attribute information of each labeled sample, when the attribute information corresponding to the to-be-predicted attribute information is actually the particular attribute information, calculate a first difference between the probability and 1; otherwise, calculate a first difference between the probability and 0; and determine the probability distribution function based on a sum of the first differences corresponding to all the labeled samples and the sum of the products of all the second differences in each field and the corresponding similarity weights.

Still further, the apparatus may further include: a correction module, configured to: correct the probability distribution function, and use the corrected probability distribution function as an estimated new probability distribution function; and stop when a quantity of corrections exceeds a preset value; or stop when all probability distribution functions converge.

According to a fifth aspect, an embodiment of the present application may provide an information determining apparatus. The apparatus is based on N fields, N is an integer greater than or equal to 2, each of the fields includes instance data of a plurality of users, each piece of instance data includes a plurality of pieces of attribute information, at least one piece of public attribute information exists in instance data of a same user in the N fields, the instance data of the same user in the N fields constitutes one sample, a feature vector of the sample is generated based on some or all of known attribute information included in the sample, and a feature vector of each sample includes a same quantity of pieces of known attribute information. The information determining apparatus may include: a processor, and a memory configured to store an executable instruction of the processor. The processor executes the executable instruction stored in the memory, so that the information determining apparatus performs the method according to the first aspect and the subdivisions thereof. For example, the information determining apparatus may perform the following steps: estimating a probability distribution function of to-be-predicted attribute information according to a feature vector of a to-be-labeled sample, where the to-be-labeled sample is a sample including at least one piece of to-be-predicted attribute information; decomposing the probability distribution function into N subfunctions that are in a one-to-one correspondence to the N fields, and decomposing the feature vector of each sample into feature subvectors that are in a one-to-one correspondence to the N fields; and obtaining a first value obtained by substituting a feature subvector of each labeled sample in each field into a corresponding subfunction. The information determining apparatus may further perform the following method steps: calculating, based on the public attribute information, a sum of first values obtained in the N fields for the same user to obtain a probability that attribute information that is in a labeled sample and that corresponds to the to-be-predicted attribute information is particular attribute information, where the labeled sample is a sample in which all attribute information included is known attribute information; determining the probability distribution function according to the probability that the attribute information that is in the labeled sample and that corresponds to the to-be-predicted attribute information is the particular attribute information and whether the attribute information is actually the particular attribute information; and determining the to-be-predicted attribute information of the to-be-labeled sample based on the determined probability distribution function and the feature vector of the to-be-labeled sample.

According to a sixth aspect, an embodiment of the present application may provide an information determining apparatus. The apparatus is based on N fields, N is an integer greater than or equal to 2, each of the fields includes instance data of a plurality of users, each piece of instance data includes a plurality of pieces of attribute information, at least one piece of public attribute information exists in instance data of a same user in the N fields, the instance data of the same user in the N fields constitutes one sample, a feature vector of the sample is generated based on some or all of known attribute information included in the sample, and a feature vector of each sample includes a same quantity of pieces of known attribute information. The information determining apparatus may include: a processor, and a memory configured to store an executable instruction of the processor. The processor executes the executable instruction stored in the memory, so that the information determining apparatus performs the method according to the second aspect and the subdivisions thereof. For example, the information determining apparatus may perform the following method steps: estimating a probability distribution function of to-be-predicted attribute information according to a feature vector of a to-be-labeled sample, where the to-be-labeled sample is a sample including at least one piece of to-be-predicted attribute information; decomposing the probability distribution function into N subfunctions that are in a one-to-one correspondence to the N fields, and decomposing the feature vector of each sample into feature subvectors that are in a one-to-one correspondence to the N fields; and obtaining a first value obtained by substituting a feature subvector of each labeled sample in each field into a corresponding subfunction. The information determining apparatus may further perform the following method steps: calculating, based on the public attribute information, a sum of first values obtained in the N fields for the same user to obtain a probability that attribute information that is in a labeled sample and that corresponds to the to-be-predicted attribute information is particular attribute information, where the labeled sample is a sample in which all attribute information included is known attribute information; determining the probability distribution function according to the probability that the attribute information that is in the labeled sample and that corresponds to the to-be-predicted attribute information is the particular attribute information and whether the attribute information is actually the particular attribute information; and determining the to-be-predicted attribute information of the to-be-labeled sample based on the determined probability distribution function and the feature vector of the to-be-labeled sample.

Embodiments of the present application may provide the information determining method and apparatus. The method may include: estimating the association relationship between the feature vector and the to-be-predicted attribute information of the to-be-labeled sample. The method may also include decomposing the association relationship into the N sub-association relationships that are in a one-to-one correspondence to the N fields, and decomposing the feature vector of each sample into the feature subvectors that are in a one-to-one correspondence to the N fields. The method may also include obtaining the first value obtained by substituting the feature subvector of each labeled sample in each field into the corresponding sub-association relationship. The method may also include calculating, based on the public attribute information, the sum of first values obtained in the N fields for the same user to obtain the estimated attribute information, where the estimated attribute information is the attribute information that is in the labeled sample, that corresponds to the to-be-predicted attribute information, and that is estimated based on the association relationship and the feature vector of the labeled sample. The method may also include determining the association relationship based on the estimated attribute information of all the labeled samples and the known attribute information corresponding to the estimated attribute information. In the process, the sum of the first values obtained in the N fields for the same user may be calculated based on the public attribute information to obtain the estimated attribute information. That is, a calculation result may be obtained from each field without a need to know attribute information of each field. The calculation result of the same user may be further calculated using the public attribute information, and finally the to-be-predicted attribute information is determined. In this way, confidentiality between data in the different fields is ensured.

### BRIEF DESCRIPTION OF THE DRAWINGS

To describe technical solutions in embodiments of the present application briefly describes the accompanying drawings required for describing the embodiments.

FIG. 1 is a flowchart of an information determining method according to an embodiment of the present application;

FIG. 2 is a flowchart of an association relationship determining method according to an embodiment of the present application;

FIG. 3 is a flowchart of an information determining method according to another embodiment of the present application;

FIG. 4 is a schematic structural diagram of an information determining apparatus according to an embodiment of the present application;

FIG. 5 is a schematic structural diagram of an information determining apparatus according to another embodiment of the present application;

FIG. 6 is a schematic structural diagram of an information determining apparatus according to still another embodiment of the present application; and

FIG. 7 is a schematic structural diagram of an information determining apparatus according to yet another embodiment of the present application.

### DETAILED DESCRIPTION OF ILLUSTRATIVE EMBODIMENTS

To make the objectives, technical solutions, and advantages of the embodiments of the present application clearer, the following describes the technical solutions in the embodiments of the present application with reference to the accompanying drawings in the embodiments of the present application.

To resolve a problem in a current system that a data analytics process based on data convergence cannot ensure confidentiality between data in different fields, the present application provides an information determining method and apparatus.

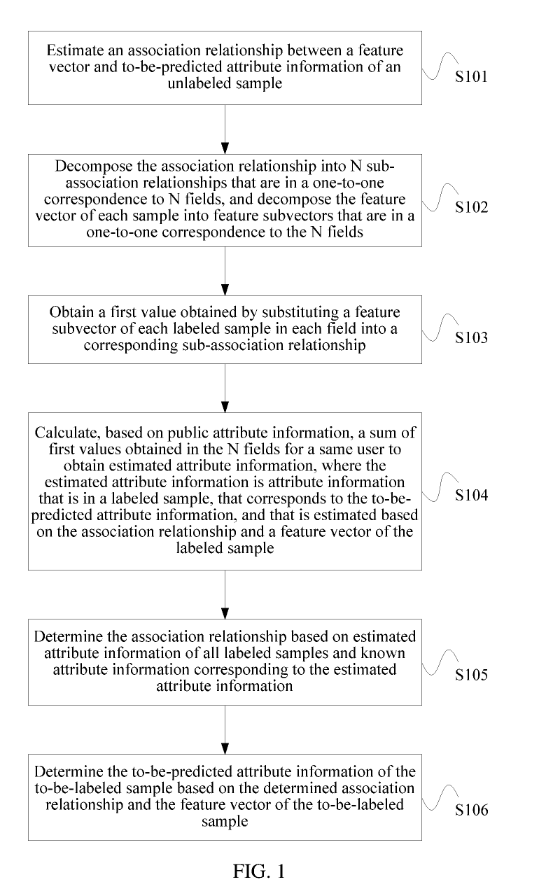

FIG. 1 is a flowchart of an information determining method according to an embodiment of the present application. The method may be applicable to a scenario of cross-field data analytics. The method is based on N fields. N may be an integer greater than or equal to 2. The N fields may be independent of each other. The N fields may be N data centers, for example, may be bank data centers or mobile operator data centers. Each data center may include at least one intelligent terminal (such as a server). The intelligent terminal may be configured to perform corresponding data processing. The method may be performed by an intelligent terminal such as a computer, a tablet computer, a mobile phone, or a server. The method may be performed by an intelligent terminal (such as a server) in any of the N fields, or may be performed by an intelligent terminal (such as a server) that does not belong to any field. Each field may include instance data of a plurality of users. Each piece of instance data may include a plurality of pieces of attribute information. At least one piece of public attribute information may exist in instance data of a same user in the N fields. Only public attribute information can be exchanged between the N fields. Attribute information that is the same between the N fields may all serve as public attribute information, for example, a name and an ID card number of a user. The instance data of the same user in the N fields may constitute one sample. When all attribute information of the sample is known attribute information, the sample may be referred to as a labeled sample; otherwise, the sample may be referred to as a to-be-labeled sample. A feature vector of the sample may be generated based on some or all known attribute information included in the sample, that is, the feature vector of the sample may include some or all known attribute information included in the sample. A feature vector of each sample may include a same quantity of pieces of known attribute information. The present application is based on the cross-field data analytics, that is, the present application aims to determine to-be-predicted attribute information of a to-be-labeled sample based on an internal data relationship of a labeled sample and known attribute information of the to-be-labeled sample.

For example, the method may be assumed to relate to two fields: mobile operators and banks. In such a scenario, instance data of a user A in a mobile operator may be: {Zhang San, 139***0000, a mobile phone fee too RMB for November, including a 50 RMB call charge and a 50 RMB traffic fee}. And instance data of the user A in a bank may be: {Zhang San, 133***0000, a service type: a financing product 1, the financing product 1 relating to an amount of 80 thousands RMB, male, age}. All instance data of the user A may constitute a to-be-labeled sample, and the related age may be to-be-predicted attribute information.

Additionally, in the foregoing example, instance data of a user B in a mobile operator may be: {Li Si, 139***0001, a mobile phone fee 78 RMB for November, including a 30 RMB call charge and a 48 RMB traffic fee}. And instance data of the user B in a bank may be: {Li Si, 139***0000, a service type: a financing product 2, the financing product 2 relating to an amount of 50 thousands RMB, female, 40}. All instance data of the user B may constitute a labeled sample.

Finally, the instance data in the foregoing example may include instance data of a user M in a mobile operator which may be defined as: {Wang Wu, 139***0010, a mobile phone fee 50 RMB for November, including a 30 RMB call charge and a to RMB traffic fee}. And may further include instance data of the user M in a bank which may be defined as: {Wang Wu, 139***0010, a service type: a deposit, relating to an amount of 2000 RMB, female, 50}. All instance data of the user M may constitute a labeled sample.

In the depicted scenario, a feature vector may be {a name, a mobile number, consumption information, a service type, an amount related to the service type}, and to-be-predicted attribute information of a to-be-labeled sample may be determined based on an internal data relationship of a labeled sample and known attribute information of the to-be-labeled sample.

As shown in FIG. 1, the method may follow the following procedure.

S101: Estimate an association relationship between a feature vector and to-be-predicted attribute information of a to-be-labeled sample.

First, it may be determined that a larger value of consumption information indicates a younger age, that is, consumption information may be inversely proportional to an age. Next, when a service type tends to be a financing product, then it may be determined that most ages may range from 30 to 45. For example, when the age is older than 40, a larger amount related to the service type may indicate a younger age. In another example, when the age is younger than 40, a larger amount related to the service type may indicate an older age. That is, an amount related to the service type may have a quadratic function relationship with an age.

Therefore, it may be estimated that the association relationship is F(Xⁱ)=−ax₁ⁱ+bx₂₁ⁱ+cx₂₂ⁱ+dx₂₃ⁱ−e(x₃ⁱ−40)²+f, where F indicates an association relationship. The feature vector is Xⁱ=(x₁ⁱ,x₂₁ⁱ,x₂₂ⁱ,x₂₃ⁱ,x₃ⁱ), where x₁ⁱ indicates consumption information of a user i in a mobile operator, x₂₁ⁱ, indicates that a service type of the user i in a bank is the financing product 1, x₂₂ⁱ indicates that the service type of the user i in the bank is the financing product 2, x₂₃ⁱ indicates that the service type is deposit, and x₃ⁱ indicates the amount related to the service type. Factors a, b, c, d, e, and f may be all positive integers. In some embodiments, the association relationship may account for more service types. Those of skill in the art will appreciate that the formulas described herein may be amended to account for additional service types. The foregoing formulas use three service types as an example only. In one example, an age of the user i that purchases the financing product 1 may be estimated, according to a labeled sample, to be younger than an age of a user that purchases the financing product 2, and the age of the user i that purchases the financing product 2 may be younger than a user that selects the deposit. In such a scenario, b>c>d may be set.

S102: Decompose the association relationship into N sub-association relationships that are in a one-to-one correspondence to the N fields, and decompose the feature vector of each sample into feature subvectors that are in a one-to-one correspondence to the N fields.

S103: Obtain a first value obtained by substituting a feature subvector of each labeled sample in each field into a corresponding sub-association relationship.

With reference to step S102 and step S103, the feature vector of the sample may include some or all known attribute information included in the sample, and therefore known attribute information included, in each field, in the feature vector of the sample may be determined. The known attribute information included in each field may be referred to as feature subvectors of the sample. Correspondingly, according to the known attribute information included, in each field, in the feature vector of the sample, a portion that is in the known attribute information included in each field and that needs to be substituted into the association relationship may be referred to as a sub-association relationship. Then, in the foregoing example, F may be decomposed into two sub-association relationships: F₁(X₁ⁱ)=−ax₁ⁱ and F₂(X₂ⁱ)=bx₂₁ⁱ+cx₂₂ⁱ+dx₂₃ⁱ−e(x₃ⁱ−40)²+f, and a corresponding feature vector may also be decomposed into two feature subvectors: X₁ⁱ=x₁ⁱ and X₂ⁱ=(x₂₁ⁱ,x₂₂ⁱ,x₂₃ⁱ,x₃ⁱ). In such a scenario, the feature vector of the labeled sample may be X^{j}, and the feature subvectors may be X₁^{j}=x₁^{j} and X₂^{j}=(x₂₁^{j},x₂₂^{j},x₂₃^{j},x₃^{j}), where two first values: F₁(X₁^{j}) and F₂ (X₂^{j}) are obtained.

S104: Calculate, based on the public attribute information, a sum of first values obtained in the N fields for the same user to obtain estimated attribute information, where the estimated attribute information is attribute information that is in a labeled sample, that corresponds to the to-be-predicted attribute information, and that is estimated based on the association relationship and a feature vector of the labeled sample.

Further, the sum of the first values obtained in the N fields for the same user may be further calculated based on encrypted public attribute information to obtain the estimated attribute information, where the public attribute information may be encrypted using a same encryption algorithm in the N fields. The public attribute information may be encrypted using the same encryption algorithm in the N fields. Therefore, for a same piece of public attribute information, results after the encryption may be the same. In this embodiment of the present application, the sum of the first values obtained in the N fields for the same user may be calculated based on encrypted public attribute information to obtain the estimated attribute information F(X). For example, the estimated attribute information may be an age of the user B, or an age of the user M.

S105: Determine the association relationship based on estimated attribute information of all labeled samples and known attribute information corresponding to the estimated attribute information.

S106: Determine the to-be-predicted attribute information of the to-be-labeled sample based on the determined association relationship and the feature vector of the to-be-labeled sample.

In an optional implementation, step S105 may include: for each labeled sample, calculating a first difference between estimated attribute information and known attribute information corresponding to the estimated attribute information; and determining the association relationship by making a sum of the first differences corresponding to all the labeled samples minimum.

For example, min Σ_{j∈L}F(X^{j})−y^{j}, where y^{j} indicates the known attribute information corresponding to the estimated attribute information, F(X^{j})−y^{j} is the first difference, and L indicates a set of all the labeled samples. Furthermore, the association relationship F may be determined by making min Σ_{j∈L}F(X^{j})−y^{j} minimum.

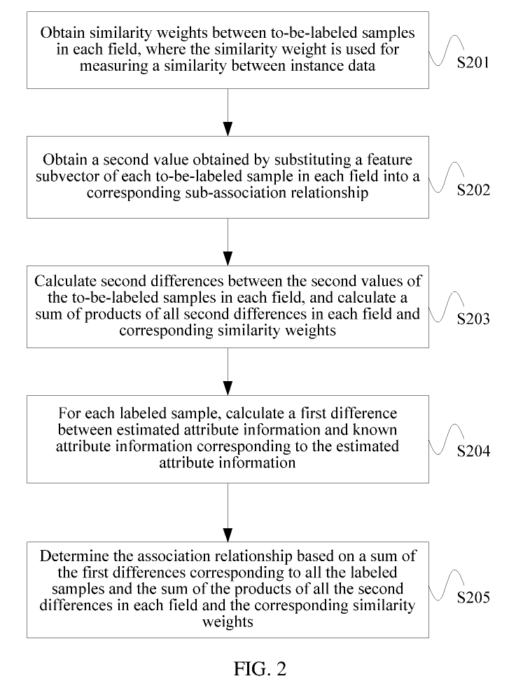

In another optional implementation, FIG. 2 illustrates a flowchart of an association relationship determining method according to an embodiment of the present application. As shown in FIG. 2, the method includes the following steps.

S201: Obtain similarity weights between to-be-labeled samples in each field, where the similarity weight is used for measuring a similarity between the instance data.

The similarity weights between the to-be-labeled samples may be determined using a cosine similarity algorithm. For example, for a field, feature subvectors corresponding to two to-be-labeled samples may be determined, and then a cosine value of an angle between the two feature subvectors may be calculated to estimate a similarity weight between the two to-be-labeled samples.

S202: Obtain a second value obtained by substituting a feature subvector of each to-be-labeled sample in each field into a corresponding sub-association relationship.

It is assumed that the feature vector of the to-be-labeled sample is X^{q}, and the feature subvectors are X₁^{q}=x₁^{q} and X₂^{q}=(x₂₁^{q},x₂₂^{q},x₂₃^{q},x₃^{q}), where two second values: F₁(X₁^{q}) and F₂(X₂^{q}) are obtained.

S203: Calculate second differences between the second values of the to-be-labeled samples in each field, and calculate a sum of products of all second differences in each field and corresponding similarity weights.

S204: For each labeled sample, calculate a first difference between estimated attribute information and known attribute information corresponding to the estimated attribute information.

S205: Determine the association relationship based on a sum of the first differences corresponding to all the labeled samples and the sum of the products of all the second differences in each field and the corresponding similarity weights.

Specifically, descriptions are provided with reference to steps S203 to S205:

minΣ_{j∈L}M(F(X^{j})−y^{j})²+Σ_{q}_{₂}_{,q}_{₂}_{∈R}aw_{q1,q2}(F₁(X₁^{q}^{₁})−F₁(X₁^{q}^{₂}))+Σ_{q}_{₁}_{,q}_{₂}_{∈R}bω_{q1,q2}(F₂(X₂^{q}^{₁})−F₂(X₂^{q}^{₂})),

where R indicates a set of all the to-be-labeled samples, and M is as large as possible. w_{q1,q2} indicates a similarity weight between labeled samples q₁ and q₂ in a field corresponding to F₁, and ω_{q1,q2} indicates a similarity weight between the labeled samples q₁ and q₂ in a field corresponding to F₂. Both F₁(X₁^{q}^{₁})−F₁(X₁^{q}^{₂}) and F₂(X₂^{q}^{₁})−F₂(X₂^{q}^{₂}) are second differences. Finally, the association relationship F is determined.

Further, after the determining the association relationship based on estimated attribute information of all labeled samples and known attribute information corresponding to the estimated attribute information, the method may further include: correcting the association relationship, and using the corrected association relationship as an estimated new association relationship; and stopping when a quantity of corrections exceeds a preset value; or stopping when all association relationships converge.

This embodiment of the present application provides the information determining method, including: estimating the association relationship between the feature vector and the to-be-predicted attribute information of the to-be-labeled sample; decomposing the association relationship into the N sub-association relationships that are in a one-to-one correspondence to the N fields, and decomposing the feature vector of each sample into the feature subvectors that are in a one-to-one correspondence to the N fields; obtaining the first value obtained by substituting the feature subvector of each labeled sample in each field into the corresponding sub-association relationship; calculating, based on the public attribute information, the sum of the first values obtained in the N fields for the same user to obtain the estimated attribute information, where the estimated attribute information is the attribute information that is in the labeled sample, that corresponds to the to-be-predicted attribute information, and that is estimated based on the association relationship and the feature vector of the labeled sample; and determining the association relationship based on the estimated attribute information of all the labeled samples and the known attribute information corresponding to the estimated attribute information. In the process, the sum of the first values obtained in the N fields for the same user may be calculated based on the public attribute information to obtain the estimated attribute information. That is, a calculation result may be obtained from each field without a need to know attribute information of each field. The calculation result of the same user is further calculated using the public attribute information, and then the to-be-predicted attribute information may be determined. In this way, confidentiality between data in the different fields may be ensured.

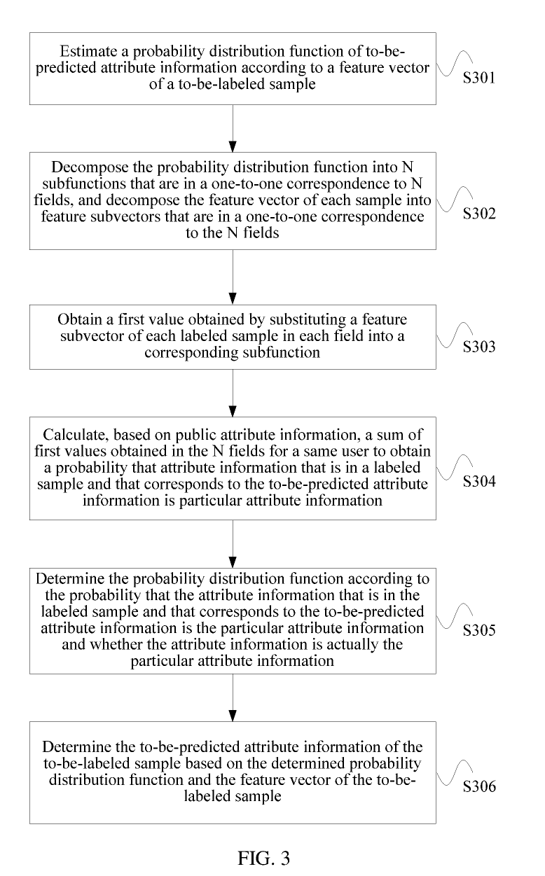

FIG. 3 depicts a flowchart of an information determining method according to another embodiment of the present application. The method may be applicable to a scenario of cross-field data analytics. The method may be performed by an intelligent terminal such as a computer, a tablet computer, or a mobile phone. The method is based on N fields, N may be an integer greater than or equal to 2, each of the fields may include instance data of a plurality of users, each piece of instance data may include a plurality of pieces of attribute information, at least one piece of public attribute information may exist in instance data of a same user in the N fields, and the instance data of the same user in the N fields may constitute one sample. When all attribute information of the sample is known attribute information, the sample may be referred to as a labeled sample; otherwise, the sample may be referred to as a to-be-labeled sample. A feature vector of the sample may be generated based on some or all known attribute information included in the sample. A feature vector of each sample may include a same quantity of pieces of known attribute information. The method, as shown in FIG. 3, may include the following steps.

S301: Estimate a probability distribution function of to-be-predicted attribute information according to a feature vector of a to-be-labeled sample.

For example, the method may be assumed to relate to two fields: mobile operators and banks. In such a scenario, instance data of a user A in a mobile operator may be: {Zhang San, 139***0000, a mobile phone fee too RMB for November, including a 50 RMB call charge and a 50 RMB traffic fee}. And instance data of the user A in a bank may be: {Zhang San, 133***0000, a service type: a financing product 1, the financing product 1 relating to an amount of 80 thousands RMB, male}. All instance data of the user A may form a to-be-labeled sample, and the related gender may be to-be-predicted attribute information.

Additionally, in the foregoing example, instance data of a user B in a mobile operator may be: {Li Si, 139***0001, a mobile phone fee 78 RMB for November, including a 30 RMB call charge and a 48 RMB traffic fee}. And instance data of the user B in a bank may be: {Li Si, 139***0000, a service type: a financing product 2, the financing product 2 relating to an amount of 50 thousands RMB, female}. All instance data of the user B may form a labeled sample.

Finally, the instance data in the foregoing example may include instance data of a user M in a mobile operator which may be defined as: {Wang Wu, 139***0010, a mobile phone fee 50 RMB for November, including a 30 RMB call charge and a to RMB traffic fee}. And may further include instance data of the user M in a bank which may be defined as: {Wang Wu, 139***0010, a service type: a deposit, relating to an amount of 2000 RMB, female}. All instance data of the user M may form a labeled sample.

In the depicted scenario, a feature vector may be {a name, a mobile number, consumption information, a service type, an amount related to the service type}, and to-be-predicted attribute information of a to-be-labeled sample may be determined based on an internal data relationship of a labeled sample and known attribute information of the to-be-labeled sample.

It may be assumed that a probability distribution function of the gender may be determined as a discrete function according to the feature vector, and a function value is 0 or 1, where 0 may indicate that the gender is male, and 1 may indicate that the gender is female.

S302: Decompose the probability distribution function into N subfunctions that are in a one-to-one correspondence to the N fields, and decompose the feature vector of each sample into feature subvectors that are in a one-to-one correspondence to the N fields.

S303: Obtain a first value obtained by substituting a feature subvector of each labeled sample in each field into a corresponding subfunction.

S304: Calculate, based on the public attribute information, a sum of first values obtained in the N fields for the same user to obtain a probability that attribute information that is in a labeled sample and that corresponds to the to-be-predicted attribute information is particular attribute information.

Further, the sum of the first values obtained in the N fields for the same user may be calculated based on encrypted public attribute information to obtain the probability that the attribute information that is in the labeled sample and that corresponds to the to-be-predicted attribute information is the particular attribute information, where the public attribute information may be encrypted using a same encryption algorithm in the N fields. Confidentiality between data can be improved using this type of encryption manner.

S305: Determine the probability distribution function according to the probability that the attribute information that is in the labeled sample and that corresponds to the to-be-predicted attribute information is the particular attribute information and whether the attribute information is actually the particular attribute information.

S306: Determine the to-be-predicted attribute information of the to-be-labeled sample based on the determined probability distribution function and the feature vector of the to-be-labeled sample.

With reference to this embodiment of the present application, the particular attribute information may include: male and female.

In an exemplary embodiment, the determining the probability distribution function according to the probability that the attribute information that is in the labeled sample and that corresponds to the to-be-predicted attribute information may be the particular attribute information and whether the attribute information is actually the particular attribute information may include: when the attribute information that is in the labeled sample and that corresponds to the to-be-predicted attribute information corresponds to m pieces of particular attribute information, where m is a positive integer greater than or equal to 2, for each piece of the particular attribute information of each labeled sample, when the attribute information corresponding to the to-be-predicted attribute information is actually the particular attribute information, calculating a first difference between the probability and 1; otherwise, calculating a first difference between the probability and 0; and determining the probability distribution function by making a sum of all first differences minimum.

In another embodiment, the method may further include: obtaining similarity weights between to-be-labeled samples in each field, where the similarity weight is used for measuring a similarity between the instance data; obtaining a second value obtained by substituting a feature subvector of each to-be-labeled sample in each field into a corresponding subfunction; and calculating second differences between the values of the to-be-labeled samples in each field, and calculating a sum of products of all second differences in each field and corresponding similarity weights; and the determining the probability distribution function according to the probability that the attribute information that is in the labeled sample and that corresponds to the to-be-predicted attribute information is the particular attribute information and whether the attribute information is actually the particular attribute information includes: for each piece of the particular attribute information of each labeled sample, when the attribute information corresponding to the to-be-predicted attribute information is actually the particular attribute information, calculating a first difference between the probability and 1; otherwise, calculating a first difference between the probability and 0.

Optionally, the probability distribution function may be determined based on a sum of the first differences corresponding to all the labeled samples and the sum of the products of all the second differences in each field and the corresponding similarity weights.

Optionally, the probability distribution function may be determined based on a difference between the probability and a preset value, a sum of the first differences corresponding to all the labeled samples, and the sum of the products of all the second differences in each field and the corresponding similarity weights. Preset values of all users may constitute a prior matrix.

Further, after the determining the probability distribution function according to the probability that the attribute information that is in the labeled sample and that corresponds to the to-be-predicted attribute information is the particular attribute information and whether the attribute information is actually the particular attribute information, the method may further include: correcting the probability distribution function, and using the corrected probability distribution function as an estimated new probability distribution function; and stopping when a quantity of corrections exceeds a preset value; or stopping when all probability distribution functions converge.

The embodiments of the present application may provide for an information determining method, comprising: estimating the probability distribution function of the to-be-predicted attribute information according to the feature vector of the to-be-labeled sample; decomposing the probability distribution function into the N subfunctions that are in a one-to-one correspondence to the N fields, and decomposing the feature vector of each sample into the feature subvectors that are in a one-to-one correspondence to the N fields; obtaining the first value obtained by substituting the feature subvector of each labeled sample in each field into the corresponding subfunction; calculating, based on the public attribute information, the sum of first values obtained in the N fields for the same user to obtain the probability that the attribute information that is in the labeled sample and that corresponds to the to-be-predicted attribute information is the particular attribute information; and determining the probability distribution function according to the probability that the attribute information that is in the labeled sample and that corresponds to the to-be-predicted attribute information is the particular attribute information and whether the attribute information is actually the particular attribute information. In the process, the sum of the first values obtained in the N fields for the same user is calculated based on the public attribute information to obtain the probability that the attribute information that is in the labeled sample and that corresponds to the to-be-predicted attribute information is the particular attribute information. That is, a calculation result is obtained from each field without a need to know attribute information of each field. The calculation result of the same user is further calculated using the public attribute information, and finally the to-be-predicted attribute information is determined. In this way, confidentiality between data in the different fields is ensured.

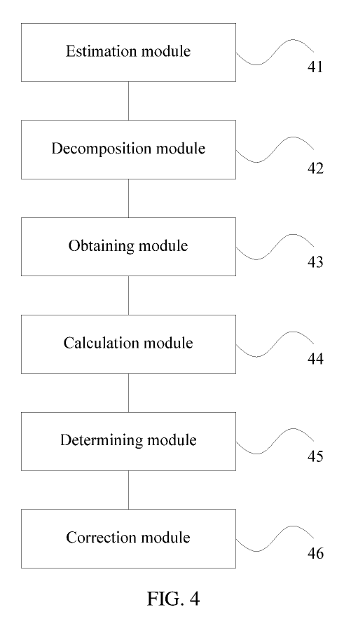

FIG. 4 illustrates a schematic structural diagram of an information determining apparatus according to an embodiment of the present application. The apparatus is based on N fields. N may be an integer greater than or equal to 2. The N fields may be independent of each other. The N fields may be N data centers, for example, may be bank data centers or mobile operator data centers. Each data center may include at least one intelligent terminal. The intelligent terminal may be configured to perform corresponding data processing. The apparatus may be an intelligent terminal such as a computer, a tablet computer, or a mobile phone. The apparatus may be an intelligent terminal in any of the N fields, or may be an intelligent terminal that does not belong to any field. Each field may include instance data of a plurality of users. Each piece of instance data may include a plurality of pieces of attribute information. At least one piece of public attribute information may exist in instance data of a same user in the N fields. Only public attribute information can be exchanged between the N fields. Attribute information that is the same between the N fields may all serve as public attribute information, for example, a name and an ID card number of a user. The instance data of the same user in the N fields may constitute one sample. When all attribute information of the sample is known attribute information, the sample may be referred to as a labeled sample; otherwise, the sample may be referred to as a to-be-labeled sample. A feature vector of the sample may be generated based on some or all known attribute information included in the sample, that is, the feature vector of the sample may include some or all known attribute information included in the sample. A feature vector of each sample may include a same quantity of pieces of known attribute information. The apparatus may include the following modules: an estimation module 41, may be configured to estimate an association relationship between a feature vector and to-be-predicted attribute information of a to-be-labeled sample, where the to-be-labeled sample is a sample including at least one piece of to-be-predicted attribute information; a decomposition module 42, may be configured to: decompose the association relationship into N sub-association relationships that are in a one-to-one correspondence to the N fields, and decompose the feature vector of each sample into feature subvectors that are in a one-to-one correspondence to the N fields; an obtaining module 43, may be configured to obtain a first value obtained by substituting a feature subvector of each labeled sample in each field into a corresponding sub-association relationship; a calculation module 44, may be configured to calculate, based on the public attribute information, a sum of first values obtained in the N fields for the same user to obtain estimated attribute information, where the estimated attribute information is attribute information that is in a labeled sample, that corresponds to the to-be-predicted attribute information, and that is estimated based on the association relationship and a feature vector of the labeled sample, and the labeled sample is a sample in which all attribute information included is known attribute information; and a determining module 45, may be configured to determine the association relationship based on estimated attribute information of all labeled samples and known attribute information corresponding to the estimated attribute information; and the determining module 45 may be further configured to determine the to-be-predicted attribute information of the to-be-labeled sample based on the determined association relationship and the feature vector of the to-be-labeled sample.

Further, the calculation module 44 may be configured to calculate, based on encrypted public attribute information, the sum of the first values obtained in the N fields for the same user to obtain the estimated attribute information, where the public attribute information is encrypted using a same encryption algorithm in the N fields.

Still further, the determining module 45 may be configured to: for each labeled sample, calculate a first difference between estimated attribute information and known attribute information corresponding to the estimated attribute information; and determine the association relationship by making a sum of the first differences corresponding to all the labeled samples minimum.

Optionally, the obtaining module 43 may be further configured to: obtain similarity weights between to-be-labeled samples in each field, where the similarity weight is used for measuring a similarity between the instance data; and obtain a second value obtained by substituting a feature subvector of each to-be-labeled sample in each field into a corresponding sub-association relationship. The calculation module 44 may be further configured to: calculate second differences between the second values of the to-be-labeled samples in each field, and calculate a sum of products of all second differences in each field and corresponding similarity weights. The determining module 45 may be configured to: for each labeled sample, calculate a first difference between estimated attribute information and known attribute information corresponding to the estimated attribute information; and determine the association relationship based on a sum of the first differences corresponding to all the labeled samples and the sum of the products of all the second differences in each field and the corresponding similarity weights.

In some embodiments, the apparatus may further include: a correction module 46, which may be configured to: correct the association relationship, and use the corrected association relationship as an estimated new association relationship; and stop when a quantity of corrections exceeds a preset value; or stop when all association relationships converge.

The information determining apparatus provided in this embodiment may be used to perform the method steps in the embodiments shown in FIG. 1 and FIG. 2. The implementation principles and technical effects thereof are similar, and are not repeated herein.

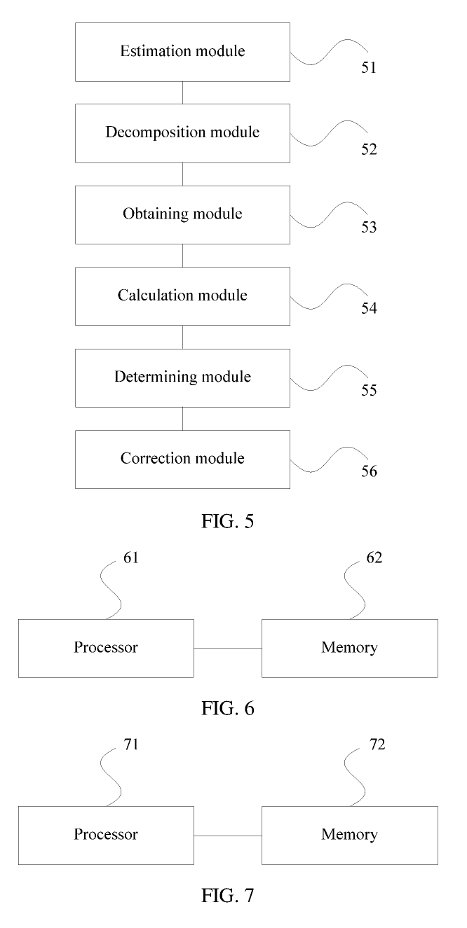

FIG. 5 depicts a schematic structural diagram of an information determining apparatus according to another embodiment of the present application. The apparatus is based on N fields, N may be an integer greater than or equal to 2, each of the fields may include instance data of a plurality of users, each piece of instance data may include a plurality of pieces of attribute information, at least one piece of public attribute information may exist in instance data of a same user in the N fields, the instance data of the same user in the N fields may constitute one sample, a feature vector of the sample may be generated based on some or all of known attribute information included in the sample, a feature vector of each sample may include a same quantity of pieces of known attribute information, and the apparatus may include: an estimation module 51, which may be configured to estimate a probability distribution function of to-be-predicted attribute information according to a feature vector of a to-be-labeled sample, where the to-be-labeled sample is a sample including at least one piece of to-be-predicted attribute information; a decomposition module 52, which may be configured to: decompose the probability distribution function into N subfunctions that are in a one-to-one correspondence to the N fields, and decompose the feature vector of each sample into feature subvectors that are in a one-to-one correspondence to the N fields; an obtaining module 53, c which may be configured to obtain a first value obtained by substituting a feature subvector of each labeled sample in each field into a corresponding subfunction; a calculation module 54, which may be configured to calculate, based on the public attribute information, a sum of first values obtained in the N fields for the same user to obtain a probability that attribute information that is in a labeled sample and that corresponds to the to-be-predicted attribute information is particular attribute information, where the labeled sample is a sample in which all attribute information included is known attribute information; and a determining module 55, which may be configured to determine the probability distribution function according to the probability that the attribute information that is in the labeled sample and that corresponds to the to-be-predicted attribute information is the particular attribute information and whether the attribute information is actually the particular attribute information; and the determining module 55 may be further configured to determine the to-be-predicted attribute information of the to-be-labeled sample based on the determined probability distribution function and the feature vector of the to-be-labeled sample.

Further, the calculation module 54 may be configured to calculate, based on encrypted public attribute information, the sum of the first values obtained in the N fields for the same user to obtain the probability that the attribute information that is in the labeled sample and that corresponds to the to-be-predicted attribute information is the particular attribute information, where the public attribute information is encrypted using a same encryption algorithm in the N fields.

Optionally, the determining module 55 may be configured to: when the attribute information that is in the labeled sample and that corresponds to the to-be-predicted attribute information corresponds to m pieces of particular attribute information, where m is a positive integer greater than or equal to 2, for each piece of the particular attribute information of each labeled sample, when the attribute information corresponding to the to-be-predicted attribute information is actually the particular attribute information, calculate a first difference between the probability and 1; otherwise, calculate a first difference between the probability and 0; and determine the probability distribution function by making a sum of all first differences minimum.

Optionally, the obtaining module 53 may be further configured to: obtain similarity weights between to-be-labeled samples in each field, where the similarity weight is used for measuring a similarity between the instance data; and obtain a second value obtained by substituting a feature subvector of each to-be-labeled sample in each field into a corresponding subfunction. The calculation module 54 may be further configured to: calculate second differences between the values of the to-be-labeled samples in each field, and calculate a sum of products of all second differences in each field and corresponding similarity weights. The determining module 55 may be configured to: for each piece of the particular attribute information of each labeled sample, when the attribute information corresponding to the to-be-predicted attribute information is actually the particular attribute information, calculate a first difference between the probability and 1; otherwise, calculate a first difference between the probability and 0; and determine the probability distribution function based on a sum of the first differences corresponding to all the labeled samples and the sum of the products of all the second differences in each field and the corresponding similarity weights.

In some embodiments, the apparatus may further include: a correction module 56, which may be configured to: correct the probability distribution function, and use the corrected probability distribution function as an estimated new probability distribution function; and stop when a quantity of corrections exceeds a preset value; or stop when all probability distribution functions converge.

The information determining apparatus provided in this embodiment may be used to perform the method steps in the embodiment shown in FIG. 3. The implementation principles and technical effects thereof are similar, and are not repeated herein.

FIG. 6 is a schematic structural diagram of an information determining apparatus according to still another embodiment of the present application. The apparatus is based on N fields, N may be an integer greater than or equal to 2, each of the fields may include instance data of a plurality of users, each piece of instance data may include a plurality of pieces of attribute information, at least one piece of public attribute information may exist in instance data of a same user in the N fields, the instance data of the same user in the N fields may constitute one sample, a feature vector of the sample may be generated based on some or all of known attribute information included in the sample, and a feature vector of each sample may include a same quantity of pieces of known attribute information. The information determining apparatus shown in FIG. 6 may include: a processor 61, and a memory 62 that may be configured to store executable instructions of the processor 61. The processor 61 may execute the executable instructions stored in the memory 62, so that the information determining apparatus performs the method steps shown in FIG. 1 or FIG. 2, for example, performs the following method steps, comprising: estimating a probability distribution function of to-be-predicted attribute information according to a feature vector of a to-be-labeled sample, where the to-be-labeled sample is a sample including at least one piece of to-be-predicted attribute information; decomposing the probability distribution function into N subfunctions that are in a one-to-one correspondence to the N fields, and decomposing the feature vector of each sample into feature subvectors that are in a one-to-one correspondence to the N fields; obtaining a first value obtained by substituting a feature subvector of each labeled sample in each field into a corresponding subfunction; calculating, based on the public attribute information, a sum of first values obtained in the N fields for the same user to obtain a probability that attribute information that is in a labeled sample and that corresponds to the to-be-predicted attribute information is particular attribute information, where the labeled sample is a sample in which all attribute information included is known attribute information; determining the probability distribution function according to the probability that the attribute information that is in the labeled sample and that corresponds to the to-be-predicted attribute information is the particular attribute information and whether the attribute information is actually the particular attribute information; and determining the to-be-predicted attribute information of the to-be-labeled sample based on the determined probability distribution function and the feature vector of the to-be-labeled sample.

The information determining apparatus provided in this embodiment may be used to perform the method steps in the embodiments shown in FIG. 1 and FIG. 2. The implementation principles and technical effects thereof are similar, and are not repeated herein.

FIG. 7 is a schematic structural diagram of an information determining apparatus according to yet another embodiment of the present application. The apparatus is based on N fields, N may be an integer greater than or equal to 2, each of the fields may include instance data of a plurality of users, each piece of instance data may include a plurality of pieces of attribute information, at least one piece of public attribute information may exist in instance data of a same user in the N fields, the instance data of the same user in the N fields may constitute one sample, a feature vector of the sample may be generated based on some or all of known attribute information included in the sample, and a feature vector of each sample may include a same quantity of pieces of known attribute information. The information determining apparatus shown in FIG. 7 may include: a processor 71, and a memory 72 that may be configured to store executable instructions of the processor 71. The processor 71 may execute the executable instructions stored in the memory 72, so that the information determining apparatus performs the method steps shown in FIG. 3, for example, performs the following method steps, comprising: estimating a probability distribution function of to-be-predicted attribute information according to a feature vector of a to-be-labeled sample, where the to-be-labeled sample is a sample including at least one piece of to-be-predicted attribute information; decomposing the probability distribution function into N subfunctions that are in a one-to-one correspondence to the N fields, and decomposing the feature vector of each sample into feature subvectors that are in a one-to-one correspondence to the N fields; obtaining a first value obtained by substituting a feature subvector of each labeled sample in each field into a corresponding subfunction; calculating, based on the public attribute information, a sum of first values obtained in the N fields for the same user to obtain a probability that attribute information that is in a labeled sample and that corresponds to the to-be-predicted attribute information is particular attribute information, where the labeled sample is a sample in which all attribute information included is known attribute information; determining the probability distribution function according to the probability that the attribute information that is in the labeled sample and that corresponds to the to-be-predicted attribute information is the particular attribute information and whether the attribute information is actually the particular attribute information; and determining the to-be-predicted attribute information of the to-be-labeled sample based on the determined probability distribution function and the feature vector of the to-be-labeled sample.

The information determining apparatus provided in this embodiment may be used to perform the method steps in the embodiment shown in FIG. 3. The implementation principles and technical effects thereof are similar, and are not repeated herein.

An embodiment of the present application may further provide a computer program product, including a computer readable storage medium. The storage medium may be configured to store computer executable instructions, and the computer executable instructions may include instructions for performing the foregoing method steps. Persons of ordinary skill in the art may understand that all or some of the steps of the method embodiments may be implemented by a program instructing relevant hardware. The program may be stored in a non-transitory computer-readable storage medium. When the program runs, the steps of the method embodiments may be performed. The foregoing storage medium may include: any medium that can store program code, such as a read only memory (ROM), a random-access memory (RAM), a magnetic disk, or an optical disc.

Finally, it should be noted that, the foregoing embodiments are merely intended for describing the technical solutions of the present application other than limiting the present application. Although the present application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present application.

What is claimed is:

1. A method, comprising:
estimating an association relationship between a feature vector and to-be-predicted attribute information of a to-be-labeled sample, wherein the to-be-labeled sample comprises at least one piece of to-be-predicted attribute information, wherein each field of N fields comprises instance data of a plurality of users, wherein each piece of instance data comprises a plurality of pieces of attribute information, wherein at least one piece of public attribute information exists in instance data of each respective user of the plurality of users in the N fields, wherein for each user, the instance data of the respective user in each field of the N fields is one sample, wherein a feature vector of each sample of a plurality of samples corresponding to the plurality of users is generated based on a portion of known attribute information comprised in the respective sample, wherein the feature vector of each sample of the plurality of samples comprises a same quantity of pieces of known attribute information, and wherein N is an integer greater than or equal to 2;
decomposing the association relationship into N sub-association relationships that are in a one-to-one correspondence to the N fields, and decomposing the feature vector of each sample of the plurality of samples into N feature subvectors that are in a one-to-one correspondence to the N fields;
for each labeled sample in a plurality of labeled samples, obtaining a plurality of first values by substituting a respective feature subvector of the respective labeled sample in each field of the N fields into a corresponding sub-association relationship, wherein attribute information comprised in each labeled sample of the plurality of labeled samples is known attribute information, and wherein the plurality of labeled samples are comprised in the plurality of samples;
for each labeled sample in a plurality of labeled samples, calculating, based on the public attribute information, a sum of the plurality of first values for a respective user corresponding to the respective labeled sample to obtain estimated attribute information of the respective labeled sample, wherein the estimated attribute information of the respective labeled sample corresponds to the to-be-predicted attribute information, and wherein the estimated attribute information of the respective labeled sample is estimated based on the association relationship and a respective feature vector of the respective labeled sample;
determining the association relationship based on estimated attribute information of each labeled sample of the plurality of labeled samples and known attribute information corresponding to the estimated attribute information of each labeled sample of the plurality of labeled samples; and
determining the to-be-predicted attribute information of the to-be-labeled sample based on the determined association relationship and the feature vector of the to-be-labeled sample.

2. The method according to claim 1, wherein the calculating the sum of the plurality of first values comprises:
calculating, based on encrypted public attribute information, the sum of the plurality of first values for the respective user corresponding to the respective labeled sample to obtain the estimated attribute information of the respective labeled sample, wherein the public attribute information is encrypted by using a same encryption algorithm in the N fields.

3. The method according to claim 1, wherein the determining the association relationship based on the estimated attribute information comprises:
for each labeled sample of the plurality of labeled samples, calculating a first difference between the estimated attribute information of the respective labeled sample and known attribute information corresponding to the estimated attribute information of each labeled sample of the plurality of labeled samples; and
determining the association relationship that yields a minimum result value for a sum of a plurality of first differences corresponding to the first difference of each labeled sample of the plurality of labeled samples.

4. The method according to claim 1, further comprising:
obtaining similarity weights for each field in the N fields between pairs of to-be-labeled samples in a plurality of to-be-labeled samples, wherein the similarity weights measure similarities between the instance data;
obtaining a plurality of second values by substituting a feature subvector of each to-be-labeled sample of the plurality of to-be-labeled samples in each field of the N fields into a corresponding sub-association relationship; and
for each to-be-labeled sample of the plurality of to-be-labeled samples, calculating a second difference between second values of the respective to-be-labeled sample in each field of the N fields, and calculating a sum of products of a plurality of second differences in each field and corresponding similarity weights; and
wherein the determining the association relationship based on the estimated attribute information comprises:
for each labeled sample of the plurality of labeled samples, calculating a first difference between estimated attribute information of the respective labeled sample and known attribute information corresponding to the estimated attribute information of each labeled sample of the plurality of labeled samples; and
determining the association relationship based on a sum of a plurality of first differences corresponding to the plurality of labeled samples and a sum of products of the plurality of second differences in each field of the N fields and corresponding similarity weights.

5. The method according to claim 1, further comprising:
after the determining the association relationship based on the estimated attribute information:
correcting the association relationship, and using the corrected association relationship as an estimated new association relationship; and
stopping when a quantity of corrections exceeds a preset value; or
stopping when all association relationships converge.

6. A method, comprising:
estimating a probability distribution function of to-be-predicted attribute information according to a feature vector of a to-be-labeled sample, wherein the to-be-labeled sample comprises at least one piece of to-be-predicted attribute information, wherein each field of N fields comprises instance data of a plurality of users, wherein each piece of instance data comprises a plurality of pieces of attribute information, wherein at least one piece of public attribute information exists in instance data of each respective user of the plurality of users in the N fields, wherein for each user, the instance data of the respective user in each field of the N fields is one sample, wherein a feature vector of each sample of a plurality of samples corresponding to the plurality of users is generated based on a portion of known attribute information comprised in the respective sample, wherein the feature vector of each sample of the plurality of samples comprises a same quantity of pieces of known attribute information, and wherein N is an integer greater than or equal to 2;
decomposing the probability distribution function into N subfunctions that are in a one-to-one correspondence to the N fields, and decomposing the feature vector of each sample of the plurality of samples into N feature subvectors that are in a one-to-one correspondence to the N fields;
for each labeled sample in a plurality of labeled samples, obtaining a plurality of first values by substituting a respective feature subvector of the respective labeled sample in each field of the N fields into a corresponding subfunction, wherein attribute information comprised in each labeled sample of the plurality of labeled samples is known attribute information, and wherein the plurality of labeled samples are comprised in the plurality of samples;
for each labeled sample in a plurality of labeled samples, calculating, based on the public attribute information, a sum of the plurality of first values for a respective user corresponding to the respective labeled sample to obtain a probability of the respective labeled sample that attribute information of the respective labeled sample corresponding to the to-be-predicted attribute information is particular attribute information;
determining the probability distribution function according to the probability of each labeled sample of the plurality of labeled samples that the attribute information of the respective labeled sample corresponding to the to-be-predicted attribute information is the particular attribute information and whether the attribute information of the respective labeled sample matches the particular attribute information; and
determining the to-be-predicted attribute information of the to-be-labeled sample based on the determined probability distribution function and the feature vector of the to-be-labeled sample.

7. The method according to claim 6, wherein the calculating the sum of the plurality of first values comprises:
calculating, based on encrypted public attribute information, the sum of the plurality of first values for the respective user corresponding to the respective labeled sample to obtain the probability that the attribute information of the respective labeled sample corresponding to the to-be-predicted attribute information is the particular attribute information, wherein the public attribute information is encrypted by using a same encryption algorithm in the N fields.

8. The method according to claim 6, wherein the determining the probability distribution function comprises:
when the attribute information of the respective labeled sample corresponding to the to-be-predicted attribute information corresponds to M pieces of particular attribute information, wherein M is a positive integer greater than or equal to 2:
for each piece of the M pieces of the particular attribute information of each labeled sample of the plurality of labeled samples, when the attribute information corresponding to the to-be-predicted attribute information matches the particular attribute information, calculating a first difference between the probability of the respective labeled sample and 1; otherwise, calculating a first difference between the probability of the respective labeled sample and 0; and
determining the probability distribution function that yields a minimum result value for a sum of a plurality of first differences corresponding to the first difference of each labeled sample of the plurality of labeled samples.

9. The method according to claim 6, further comprising:
obtaining similarity weights for each field in the N fields between pairs of to-be-labeled samples in a plurality of to-be-labeled samples, wherein the similarity weights measure similarities between the instance data;
obtaining a plurality of second values by substituting a feature subvector of each to-be-labeled sample of the plurality of to-be-labeled samples in each field of the N fields into a corresponding subfunction; and
for each to-be-labeled sample of the plurality of to-be-labeled samples, calculating a second difference between second values of the respective to-be-labeled sample in each field of the N fields, and calculating a sum of products of a plurality of second differences in each field and corresponding similarity weights; and
wherein the determining the probability distribution function according to the probability comprises:
for each piece of the particular attribute information of each labeled sample of the plurality of labeled samples, when the attribute information corresponding to the to-be-predicted attribute information matches the particular attribute information, calculating a first difference between the probability of the respective labeled sample and 1; otherwise, calculating a first difference between the probability of the respective labeled sample and 0; and
determining the probability distribution function based on a sum of a plurality of first differences corresponding to the plurality of labeled samples and a sum of products of the plurality of second differences in each field of the N fields and corresponding similarity weights.

10. The method according to claim 6, further comprising:
after the determining the probability distribution function according to the probability of the respective labeled sample:
correcting the probability distribution function, and using the corrected probability distribution function as an estimated new probability distribution function; and
stopping when a quantity of corrections exceeds a preset value; or
stopping when all probability distribution functions converge.

11. An information determining apparatus, comprising:
a processor; and
a non-transitory computer-readable storage medium coupled to the processor and storing instructions for execution by the processor, and the instructions instruct the processor to:
estimate an association relationship between a feature vector and to-be-predicted attribute information of a to-be-labeled sample, wherein the to-be-labeled sample comprises at least one piece of to-be-predicted attribute information, wherein each field of N fields comprises instance data of a plurality of users, wherein each piece of instance data comprises a plurality of pieces of attribute information, wherein at least one piece of public attribute information exists in instance data of each respective user of the plurality of users in the N fields, wherein for each user, the instance data of the respective user in each field of the N fields is one sample, wherein a feature vector of each sample of a plurality of samples corresponding to the plurality of users is generated based on a portion of known attribute information comprised in the respective sample, wherein the feature vector of each sample of the plurality of samples comprises a same quantity of pieces of known attribute information, and wherein N is an integer greater than or equal to 2;
decompose the association relationship into N sub-association relationships that are in a one-to-one correspondence to the N fields, and decompose the feature vector of each sample of the plurality of samples into N feature subvectors that are in a one-to-one correspondence to the N fields;
for each labeled sample in a plurality of labeled samples, obtain a plurality of first values by substituting a respective feature subvector of the respective labeled sample in each field of the N fields into a corresponding sub-association relationship, wherein attribute information comprised in each labeled sample of the plurality of labeled samples is known attribute information, and wherein the plurality of labeled samples are comprised in the plurality of samples;
for each labeled sample in a plurality of labeled samples, calculate, based on the public attribute information, a sum of the plurality of first values for a respective user corresponding to the respective labeled sample to obtain estimated attribute information of the respective labeled sample, wherein the estimated attribute information of the respective labeled sample corresponds to the to-be-predicted attribute information, and wherein the estimated attribute information of the respective labeled sample is estimated based on the association relationship and a respective feature vector of the respective labeled sample;
determine the association relationship based on estimated attribute information of each labeled sample of the plurality of labeled samples and known attribute information corresponding to the estimated attribute information of each labeled sample of the plurality of labeled samples; and
determine the to-be-predicted attribute information of the to-be-labeled sample based on the determined association relationship and the feature vector of the to-be-labeled sample.

12. The apparatus according to claim 11, wherein the instructions further instruct the processor to:
calculate, based on encrypted public attribute information, the sum of the plurality of first values for the respective user corresponding to the respective labeled sample to obtain the estimated attribute information of the respective labeled sample, wherein the public attribute information is encrypted by using a same encryption algorithm in the N fields.

13. The apparatus according to claim 11, wherein the instructions further instruct the processor to:
for each labeled sample of the plurality of labeled samples, calculate a first difference between the estimated attribute information of the respective labeled sample and known attribute information corresponding to the estimated attribute information of each labeled sample of the plurality of labeled samples; and
determine the association relationship that yields a minimum result value for a sum of a plurality of first differences corresponding to the first difference of each labeled sample of the plurality of labeled samples.

14. The apparatus according to claim 11, wherein the instructions further instruct the processor to:
obtain similarity weights for each field in the N fields between pairs of to-be-labeled samples in a plurality of to-be-labeled samples, wherein the similarity weights measure similarities between the instance data; and
obtain a plurality of second values by substituting a feature subvector of each to-be-labeled sample of the plurality of to-be-labeled samples in each field of the N fields into a corresponding sub-association relationship;
for each to-be-labeled sample of the plurality of to-be-labeled samples, calculate a second difference between second values of the respective to-be-labeled sample in each field of the N fields, and calculate a sum of products of a plurality of second differences in each field and corresponding similarity weights; and
for each labeled sample of the plurality of labeled samples, calculate a first difference between estimated attribute information of the respective labeled sample and known attribute information corresponding to the estimated attribute information of each labeled sample of the plurality of labeled samples; and
determine the association relationship based on a sum of a plurality of first differences corresponding to the plurality of labeled samples and a sum of products of the plurality of second differences in each field of the N fields and corresponding similarity weights.

15. The apparatus according to claim 11, wherein the instructions further instruct the processor to:
correct the association relationship, and use the corrected association relationship as an estimated new association relationship; and
stop when a quantity of corrections exceeds a preset value; or
stop when all association relationships converge.

16. An information determining apparatus, comprising:
a processor; and
a non-transitory computer-readable storage medium coupled to the processor and storing instructions for execution by the processor, and the instructions instruct the processor to:
estimate a probability distribution function of to-be-predicted attribute information according to a feature vector of a to-be-labeled sample, wherein the to-be-labeled sample comprises at least one piece of to-be-predicted attribute information, wherein each field of N fields comprises instance data of a plurality of users, wherein each piece of instance data comprises a plurality of pieces of attribute information, wherein at least one piece of public attribute information exists in instance data of each respective user of the plurality of users in the N fields, wherein for each user, the instance data of the respective user in each field of the N fields is one sample, wherein a feature vector of each sample of a plurality of samples corresponding to the plurality of users is generated based on a portion of known attribute information comprised in the respective sample, wherein the feature vector of each sample of the plurality of samples comprises a same quantity of pieces of known attribute information, and wherein N is an integer greater than or equal to 2;
decompose the probability distribution function into N subfunctions that are in a one-to-one correspondence to the N fields, and decompose the feature vector of each sample of the plurality of samples into N feature subvectors that are in a one-to-one correspondence to the N fields;
for each labeled sample in a plurality of labeled samples, obtain a plurality of first values by substituting a respective feature subvector of the respective labeled sample in each field of the N fields into a corresponding subfunction, wherein attribute information comprised in each labeled sample of the plurality of labeled samples is known attribute information, and wherein the plurality of labeled samples are comprised in the plurality of samples;
for each labeled sample in a plurality of labeled samples, calculate, based on the public attribute information, a sum of the plurality of first values for a respective user corresponding to the respective labeled sample to obtain a probability of the respective labeled sample that attribute information of the respective labeled sample corresponding to the to-be-predicted attribute information is particular attribute information;
determine the probability distribution function according to the probability of each labeled sample of the plurality of labeled samples that the attribute information of the respective labeled sample corresponding to the to-be-predicted attribute information is the particular attribute information and whether the attribute information of the respective labeled sample matches the particular attribute information; and
determine the to-be-predicted attribute information of the to-be-labeled sample based on the determined probability distribution function and the feature vector of the to-be-labeled sample.

17. The apparatus according to claim 16, wherein the instructions further instruct the processor to:
calculate, based on encrypted public attribute information, the sum of the plurality of first values for the respective user corresponding to the respective labeled sample to obtain the probability that the attribute information of the respective labeled sample corresponding to the to-be-predicted attribute information is the particular attribute information, wherein the public attribute information is encrypted by using a same encryption algorithm in the N fields.

18. The apparatus according to claim 16, wherein the instructions further instruct the processor to:
when the attribute information of the labeled sample corresponding to the to-be-predicted attribute information corresponds to M pieces of particular attribute information, wherein M is a positive integer greater than or equal to 2:
for each piece of the M pieces of the particular attribute information of each labeled sample of the plurality of labeled samples, when the attribute information corresponding to the to-be-predicted attribute information matches the particular attribute information, calculate a first difference between the probability of the respective labeled sample and 1; otherwise, calculate a first difference between the probability of the respective labeled sample and 0; and
determine the probability distribution function that yields a minimum result value for a sum of a plurality of first differences corresponding to the first difference of each labeled sample of the plurality of labeled samples.

19. The apparatus according to claim 16, wherein the instructions further instruct the processor to:
obtain similarity weights for each field in the N fields between pairs of to-be-labeled samples in a plurality of to-be-labeled samples, wherein the similarity weights measure similarities between the instance data;
obtain a plurality of second values by substituting a feature subvector of each to-be-labeled sample of the plurality of to-be-labeled samples in each field of the N fields into a corresponding subfunction;
for each to-be-labeled sample of the plurality of to-be-labeled samples, calculate a second difference between second values of the respective to-be-labeled sample in each field of the N fields, and calculate a sum of products of a plurality of second differences in each field and corresponding similarity weights;
for each piece of the particular attribute information of each labeled sample of the plurality of labeled samples, when the attribute information corresponding to the to-be-predicted attribute information matches the particular attribute information, calculate a first difference between the probability of the respective labeled sample and 1; otherwise, calculate a first difference between the probability of the respective labeled sample and 0; and
determine the probability distribution function based on a sum of a plurality of first differences corresponding to the plurality of labeled samples and a sum of products of the plurality of second differences in each field of the N fields and corresponding similarity weights.

20. The apparatus according to claim 16, wherein the instructions further instruct the processor to:
correct the probability distribution function, and use the corrected probability distribution function as an estimated new probability distribution function; and
stop when a quantity of corrections exceeds a preset value; or
stop when all probability distribution functions converge.
